(19) United States
(12) Patent Application Publication
(10) Pub. No.: US 2014/0119250 A1
(43) Pub. Date: May 1, 2014

(54) MECHANISM TO FACILITATE TIMING RECOVERY IN TIME DIVISION DUPLEX SYSTEMS

(71) Applicant: IKANOS COMMUNICATIONS, INC., Fremont, CA (US)

(72) Inventors: Massimo SORBARA, Freehold, NJ (US); William Edward KEASLER, JR., Tinton Falls, NJ (US); Peter KELLER, Tinton Falls, NJ (US)

(21) Appl. No.: 14/065,888

(22) Filed: Oct. 29, 2013

Related U.S. Application Data
(60) Provisional application No. 61/719,784, filed on Oct. 29, 2012.

(51) Int. Cl. H04J 3/06; H04L 5/14

(52) U.S. Cl. CPC H04J 3/0635; H04L 5/14
USPC 370/294

(57) ABSTRACT

In general, the present invention relates to systems and methods to facilitate timing recovery and loop timing operations in a TDD communication system with significantly varying intervals of inactivity between periods of transmission. According to certain aspects, to facilitate timing recovery, embodiments of the invention define a maximum period of inactivity for each mode of transmission and associated “timing keep alive” signals during and/or between transmissions to assist the timing recovery function in the receiver. In embodiments, the receiver selects the desired format of the “timing keep alive” signal. According to further aspects, the timing recovery mechanisms of the invention maintain power saving objectives of G.fast, where power dissipation varies near linearly with traffic demand.

### CROSS REFERENCE TO RELATED APPLICATIONS

This application claims priority under 35 USC 119(e) to U.S. Provisional Patent Application No. 61/719,784, filed Oct. 29, 2012, the contents of which are hereby incorporated by reference in their entirety.

### FIELD OF THE INVENTION

In general, the present invention relates to data communications, and more particularly to systems and methods to facilitate timing recovery and loop timing operations in a time division duplex transmission system.

### BACKGROUND OF THE INVENTION

In G.fast, a goal is to define data transmission using a synchronous time division duplex (TDD) format in such a manner that allows transceiver power dissipation to scale near linearly with traffic demand. To facilitate this, several transmission states are defined. First, the normal data mode, referred to here as the L0 state, transmits data in each TDD frame. The low power states are referred to as L2.x states, where x is an indicator of the frequency in which data is sent (e.g. L.2.1 could be a state in which data is sent in one of every two TDD frames and L.2.2 could be a state where data is sent every fourth TDD frame). Several different low power states may be defined, each specifying a level of data transmission in exchange for power dissipation savings. A challenge in TDD operations with such varying intervals of data transmission inactivity is to maintain accurate timing recovery in the receiver when resuming transmission from an extended period of inactivity.

### SUMMARY OF THE INVENTION

In general, the present invention relates to systems and methods to facilitate timing recovery and loop timing operations in a TDD communication system with significantly varying intervals of inactivity between periods of transmission. According to certain aspects, to facilitate timing recovery, embodiments of the invention define a maximum period of inactivity for each mode of transmission and associated “timing keep alive” signals during and/or between transmissions to assist the timing recovery function in the receiver. In embodiments, the receiver selects the desired format of the “timing keep alive” signal. According to further aspects, the timing recovery mechanisms of the invention maintain power saving objectives of G.fast or any similar TDD transmission system, where power dissipation varies near linearly with traffic demand.

In accordance with these and other aspects, a method to facilitate timing recovery at a receiver in a time division duplex (TDD) communication system according to embodiments of the invention includes defining a maximum period of inactivity of downstream transmissions in a TDD frame, specifying timing keep alive signals, and transmitting the specified timing keep alive signals downstream to the receiver during the downstream transmissions.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIGS. 1(A) to 1(C) are timing diagrams illustrating an example implementation of G.fast timing recovery in normal data mode according to embodiments of the invention;

FIG. 2 is a block diagram illustrating an example timing recovery block in a G.fast receiver according to embodiments of the invention;

FIGS. 3(A) and 3(B) are timing diagrams illustrating residual phase error of recovered clock;

FIGS. 4(A) to 4(D) are timing diagrams illustrating adaptation of various low power modes according to embodiments of the invention; and

FIG. 5 is a block diagram illustrating an example system for implementing timing recovery mechanisms in accordance with embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In general, embodiments of the invention described below enable improved timing recovery in communications system receivers where there are extended periods of inactivity between transmissions. The embodiments will be described below in connection with a particular useful application to the different modes of G.fast communications. However, the invention is not limited to this example, and can apply to any similar TDD or other communication scheme with long periods of inactivity between transmissions. Aspects of the invention include using timing “keep alive” signals during or between transmissions. In embodiments of the invention described below these “keep alive” signals are implemented using pilot tones and/or pilot symbols. However, the invention is not limited to this example.

Operation in Normal Data (L0) Mode

The normal data mode (L0) operates with full quality of service (QoS) and maximum data throughput. It is expected that L0 mode will provide the smallest periods of inactivity when compared to the expected larger inactivity periods in the various low power (L2.x) modes utilizing discontinuous operation.

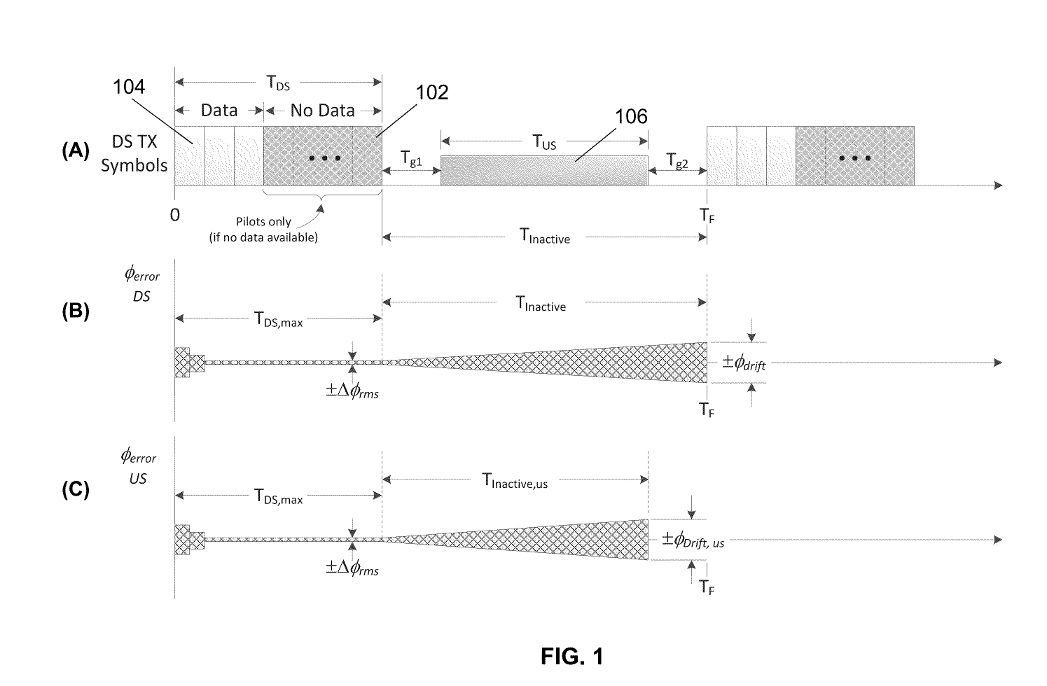

FIG. 1(A) is a timing diagram illustrating downstream OFDM symbols transmitted during normal (L0) data mode. In a TDD frame period (T_{F}), the maximum duration of the downstream transmission (T_{DS}) is set by the provisioning of the asymmetry ratio. The value defining the smallest downstream transmission time will define the maximum duration of inactivity (T_{inactive}) during a TDD frame (i.e. T_{inactive}=T_{F}−T_{DS}). While data is being transmitted downstream, the receiver may accurately recover the signals' clock and track the phase to a good accuracy. Accordingly, the steady state rms jitter about the nominal frequency during data transmission periods is identified as Δφᵣₘₛ in FIGS. 1(B) and 1(C). The achievable accuracy in the clock recovery is implementation specific. As further shown in FIGS. 1(B) and 1(C), however, during the period of downstream inactivity, the recovered clock phase will drift to a value proportional to the inactivity period (T_{inactive}).

For upstream transmission, systems generally also use the recovered clock in the downstream receiver as the transmit clock for the upstream transmitter (this is referred to as loop timing). During periods 106 of upstream transmission (i.e. T_{US}, Tg1 and Tg2 in FIG. 1(A)), the timing recovery function in the downstream receiver is not receiving any phase updates so the upstream transmit clock in the downstream receiver (i.e. the downstream receive clock) is drifting during upstream data transmission. This period is shown in FIG. 1(C) as T_{inactive,us}. When downstream transmission is resumed in the next TDD frame, the downstream receive clock phase, and thus the upstream transmit clock phase, is recovered.

It should be noted that an objective of G.fast is to have the transceiver power consumption decrease as data throughput decreases, which implies that no data symbols are being sent during the downstream transmission periods if there is no data available. In FIG. 1(A), this is indicated by the period 102 in the downstream transmission period T_{DS}. If there is no signal energy on the line during this interval, then the downstream inactivity period is increased, which causes additional drift in the recovered clock.

The present inventors recognize, however, that if there is some minimal energy during the “no data” periods, then the timing recovery function in the downstream receiver can receive phase updates throughout the duration of the designated DS transmission time and the resulting phase drift could be maintained to that expected for the defined T_{inactive} period.

To facilitate downstream timing recovery when data is transmitted, embodiments of the invention include a number of pilot tones in all data bearing OFDM symbols 104, where the indices of the specific pilot tones may be negotiated during initialization. Generally, the receiver selects the desired pilot tone indices based on the implementation of the timing recovery function. A maximum number of pilot tones and corresponding indices may be defined. For the OFDM symbol timeslots that do not contain data (i.e. periods 102 in FIG. 1(A)), the upstream transmitter loads the downstream OFDM symbols with only the pilot tones and all other tones are zeroed out. The transmit signal powers are reduced accordingly for these special symbol periods and power savings can still be achieved in accordance with G.fast, which power savings are implementation specific.

In embodiments of the invention, therefore, throughout the entire period of downstream symbol transmission, i.e. during T_{DS} periods in FIG. 1(A), the receiver accurately recovers the signal clock provided that enough symbols are received. Provisioning of one or more pilot tones in each OFDM symbol during this period facilitates accurate recovery of the transmit signal clock.

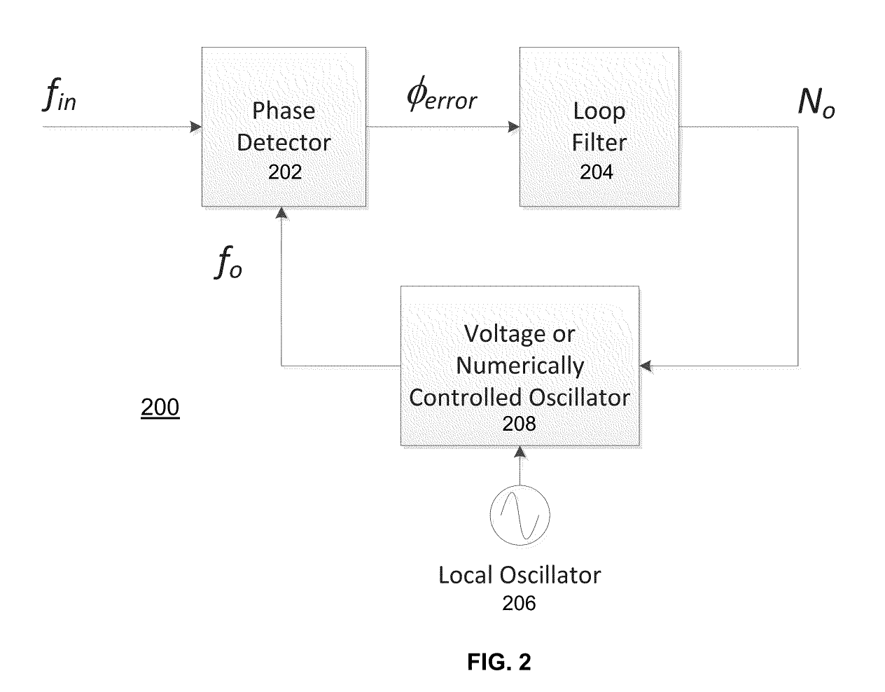

FIG. 2 is a block diagram illustrating an example timing recovery block according to embodiments of the invention, which also facilitates discussion of the key timing recovery parameters in G.fast. As shown in FIG. 2, the overall structure is that of a general phase locked loop 200. The receiver operates on the received OFDM signal that is synchronous to the transmit clock (ƒᵢₙ). The phase locked loop 200 constructs a receive clock (ƒₒ) to be both frequency and phase locked to the transmit clock ƒᵢₙ. To achieve this, the phase detector 202 computes an estimate of the phase error between the two clocks from processing of the pilot tones in the received OFDM symbols according to embodiments of the invention.

The loop filter 204 removes any high frequency phase variations, and its output (represented by the number Nₒ in FIG. 2) controls the frequency of a local oscillator 206 (typically through use of a voltage or numerically controlled oscillator 208) so as to track the frequency and phase variations with the transmit clock frequency. When the phase locked loop is locked to the transmit clock frequency (ƒᵢₙ), the loop filter 204 output Nₒ has two components associated with it: (1) the long term average, which is a measure of the nominal offset between the respective transmitter and receiver local oscillators, and (2) a variation about the long term average that represents the resulting phase jitter between the two clocks. The jitter is expressed as a ratio of the root-mean-square (rms) frequency variation Δƒ to a reference frequency ƒₒ, namely

$${Δφ}_{rms} = {( \frac{Δ f}{{f}_{o}} )}_{ppm}$$

where the quantity is typically expressed in parts per million. The achievable value of this residual phase error (i.e. jitter) when continuously receiving OFDM symbols is implementation specific (e.g. a particular clock crystal accuracy in the receiver).

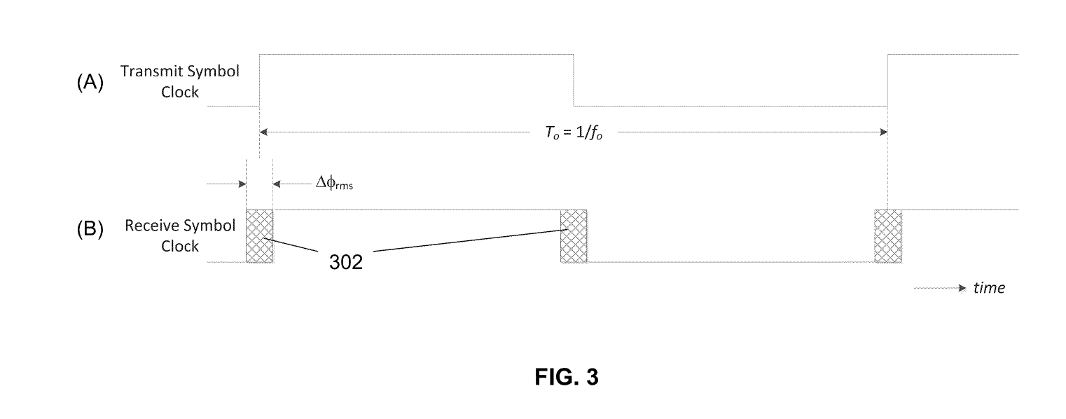

FIGS. 3(A) and 3(B) are timing diagrams to illustrate the above described relationships. FIG. 3(A) illustrates the timing of the transmit symbol clock. FIG. 3(B) illustrates the timing of the receive symbol clock, showing phase error term Δ ᵣₘₛ as a phase jitter 302 on the recovered clock.

As mentioned previously, during any period of inactivity (T_{inactive}), the residual phase error Δφᵣₘₛ at the end of the data transmission period will drift by an amount (in seconds) proportional to the duration of the inactivity period. This quantity is referred to as the phase drift φ_{drift}, which is given in seconds by the following expression:

$${φ}_{drift} = {( \frac{Δ f}{{f}_{o}} )}_{ppm} \cdot {T}_{Inactive} \qquad ( 1 )$$

Alternatively, the phase drift with respect to a given reference frequency ƒₒ may be expressed in radians as

$${φ}_{drift} = {( \frac{Δ f}{{f}_{o}} )}_{ppm} \cdot {f}_{o} \cdot {T}_{Inactive} \cdot 2 π \qquad ( 2 )$$

or in degrees by

$${φ}_{drift} = {( \frac{Δ f}{{f}_{o}} )}_{ppm} \cdot {f}_{o} \cdot {T}_{Inactive} \cdot 360 \qquad ( 3 )$$

In the above expressions, it should be noted that the maximum duration of inactivity (T_{inactive}) may be specified as part of the TDD frame definition in the PMD layer. It should be further noted that the resulting phase drift will have greater impact on the higher frequency tones and constellations with higher bit loadings. So specifying the maximum value of T _{inactive} provides implementers with an awareness of the expected phase drift based on their timing recovery circuit implementation.

To briefly assess the impact of phase drift, for a 12-bit-per-symbol (64×64 points) constellation, approximately 1 degree (17.5 mrad) of phase rotation causes the outer most point of the constellation to reach a decision boundary. The highest frequency tone (approximately 106 MHz) is most sensitive to phase drift. The angle rotation threshold (for a constellation point to reach the decision boundary) increases with decreasing sub-carrier frequency and with decreasing constellation size. As described by equations (1) through (3) above, the parameters impacting the phase drift during are the length of the inactivity period (T_{inactive}) and the level of rms phase jitter at the beginning of the inactivity period.

To help understand the level of phase jitter and inactivity interval, consider the following example: a 2048 sub-carrier system with a sub-carrier spacing of 51.75 kHz (bandwidth is approximately MHz). If there is a 400 μsec inactivity period and a reference sub-carrier frequency of 106 MHz, TABLE 1 below gives the level of phase drift at the end of the inactivity for a given rms phase jitter at the beginning of the inactivity period from equation (3).

TABLE 1

| Δφᵣₘₛ | φ_{drift} | |
|---|---|---|
| 1000 ppb | 15 | degrees (262 mrad) |
| 100 ppb | 1.5 | degrees (26.2 mrad) |
| 65 ppb | 1.0 | degree (17.5 mrad) |
| 10 ppb | 0.15 | degree (2.62 mrad) |
| 1 ppb | 0.015 | degree (0.262 mrad) |

From the above table, to ensure that signal constellation does not cross any decision boundary (i.e. the 12-bit constellation at the highest sub-carrier frequency as the worst case), it can be seen that better than 65 ppb in phase synchronization accuracy needs to be achieved. From TABLE 1, an even higher phase drift objective of ≦2 mrad would require a rms phase synchronization accuracy of better than 10 ppb. Again it is noted that the achievable rms phase accuracy (and corresponding acquisition time) is implementation dependent.

Normal data (L0) mode is expected to contain the shortest inactivity period compared to the various low power (L2.x) modes. It is understood that, in accordance with G.fast, if no data is available for transmission during any TDD frame, no data bearing OFDM symbols are transmitted so as to reduce transmit power and reduce power dissipation accordingly.

Embodiments of the invention therefore perform the following tasks during the L0 state to facilitate maintenance of loop timing:

(1) The system defines a maximum period of downstream inactivity T_{inactive} within a TDD frame. This period may be based on the provisioning of the asymmetry ratio that corresponds to the shortest interval T_{DS} for downstream data transmission.

(2) If there is no data available for downstream transmission for any symbol period of T_{DS}, the transmitter fills the remaining portion of T_{DS} with OFDM symbols containing only pilot tones and all other sub-carriers in the symbols are zeroed out. This mechanism assures that there is some minimum energy on the line in each TDD frame to keep loop timing operating properly. It should be noted that pilot tones can also be included in data bearing symbols during L0 in some embodiments.

With the inclusion of pilot tones throughout downstream transmissions, and with the worst case inactivity known, timing recovery can be performed within the necessary accuracy during the L0 state as set forth above.

Operation in Low Power (L2.x) Modes

For implementation of various low power modes, there is the potential for very long periods of no data transmission and fewer periods where data is actually transmitted. During the extended periods of no end user data being passed, the phase may have drifted by such a large amount that it may take several OFDM symbol periods to properly readjust the timing phase in the downstream receiver. In the following, example methods for addressing this issue according to embodiments of the invention are described.

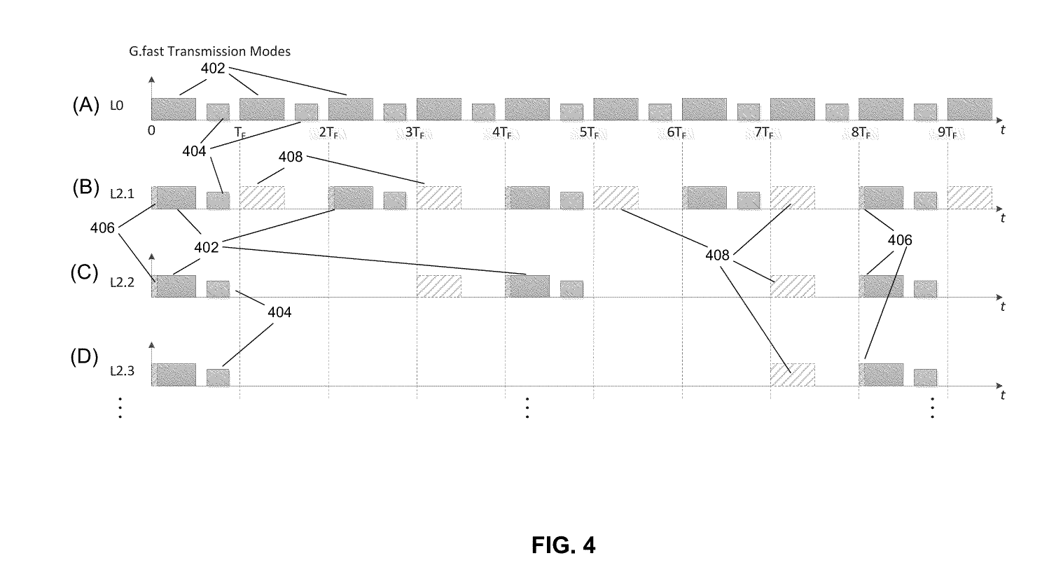

The timing diagrams in FIG. 4 give an example of the line activity for normal data mode L0 and various low power modes; the shaded slots 402 indicate periods of downstream transmission and the shaded slots 404 indicate periods of upstream transmission. As shown in FIG. 4(A), in the L0 state, data is transmitted in all TDD frames; as shown in FIG. 4(B), in L2.1 data is transmitted in alternate frames; as shown in FIG. 4(C), in L2.2 data is transmitted every 4th frame; as shown in FIG. 4(D), in L2.3 data is transmitted every 8th frame, and so on.

The following are mechanisms for assisting timing recovery in low power modes according to embodiments of the invention:

(1) When data transmission is resumed in the designated frame period, allocate one or more symbols as pilot symbols 406 before prior to sending data bearing symbols in the frame. Depending on the implementation, the receiver may select the number of pilot symbols during initialization that are to be placed at the beginning of the data transmission interval for each low power state. A different configuration may be defined for each power state.

(2) Additionally or alternatively, during the TDD frame prior to data transmission, the downstream transmission interval 408 is filled with the designated pilot tones in each of the symbol periods and all other sub-carriers are zeroed out.

Example Implementation

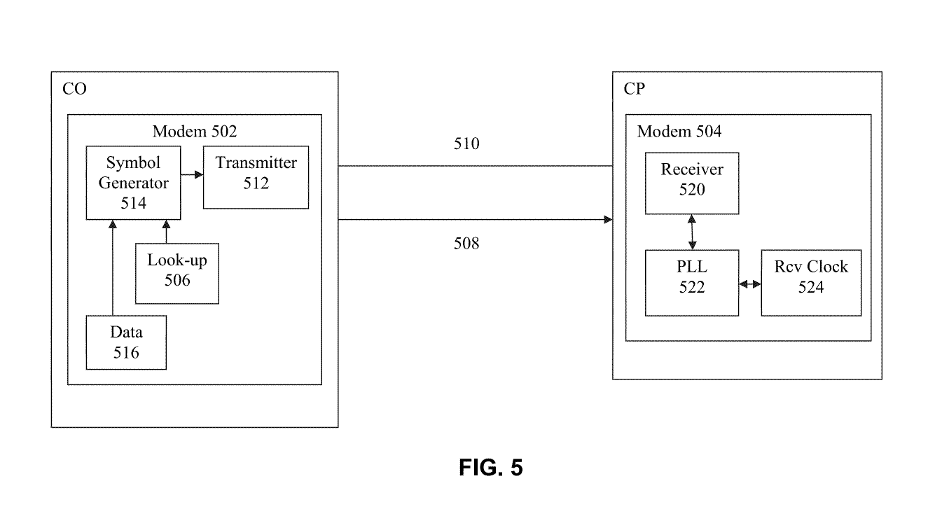

FIG. 5 is a block diagram of a system for implementing the timing recovery mechanisms for various modes of G.fast as described above.

As shown, the system includes an upstream modem 502 in a CO, for example, and a downstream modem 504 in a customer premises, for example (i.e. CPE). Modems 502 and 504 can be any DSL modem that is compatible with G.fast or similar TDD technology, such as those including DSL modem chipsets and associated software/firmware provided by Ikanos Communications, Inc. Those skilled in the art will understand how to adapt such modems with the timing recovery mechanisms of the present invention after being taught by the present disclosure.

As shown in the example implementation of FIG. 5, the symbol generator 514 of upstream modem 502 has been adapted to form symbols using both data 516 as is conventionally done, as well as from pilot tone information in memory 506. Receiver 520 in downstream modem 504 has been adapted to use the pilot tones and pilot symbols to update the receive clock 524 using PLL 522 as described above. It should be apparent that similar functionality shown in upstream modem 502 can be included in downstream modem 504, and vice-versa. It should be further apparent that modems 502 and 504 can include additional components and functionality not shown in FIG. 5.

The following will further describe items related to the implementation of the above mentioned timing recovery framework:

(1) To maximize savings on power dissipation, the formation of symbols carrying only pilot tones by symbol generator 514 may be implemented using a memory 506 (RAM or ROM) lookup technique in the upstream modem 502, where the DSP performing the normal transmit and receive function may be disabled.

(2) For the normal data (L0) state,

(a) During initialization, the upstream (i.e. CO) modem 502 and downstream (i.e. CPE) modem 504 specify the maximum duration of a downstream inactivity interval in a TDD frame (i.e. T_{inactive}) in a standard or interoperability specification. For example, during initialization, the downstream receiver may specify the number of pilot symbols needed per TDD frame during periods of inactivity to maintain timing recovery. The downstream receiver may also specify the bit loading in the downstream transmitter commensurate with the period of inactivity to assure error free transmission in the presence of extended timing drift.

(b) Also during initialization, the downstream modem 504 selects the number of pilot tones for the upstream modem 502 to include in a downstream data symbol, as well as their indices, and communicates them to the upstream modem 502.

(c) In optional embodiments, the robustness of the timing recovery may be enhanced during L0 modes by using one or more pilot symbols prior to transmitting data symbols in the downstream transmission portion of the TDD frame. The downstream modem 504 may communicate the preferred pilot tones and number of symbols to the upstream modem 502 at initialization.

(3) For each of the low power L2.x states, the transmission of data bearing symbols (both upstream and downstream) are provided in the designated TDD frames; the intermediate frames do not carry any data bearing symbols.

(4) Any combination of the following timing recovery assist mechanisms may be configured during at initialization. Note that each low power state may be configured with a different timing recovery assist method; the selection may be based on the implementation of the actual timing recovery function used in the downstream modem 504 and the number of no data (i.e. intermediate) TDD frames between the data bearing frames.

(a) All the downstream symbols in a designated data transmission frame may be configured as data bearing symbols either with or without pilot tones. This may be the same configuration as in the normal data (L0) state. The selection may be made by the downstream modem 504 during initialization.

(b) At the beginning of the TDD frame designated for data transmission, one or more pilot symbols are transmitted downstream by modem 502 prior to the transmission of normal data bearing data symbols. The pilot symbols may be data bearing and configured with an equal or greater number of pilot tones as a data symbol in normal data (L0) state. Alternatively, the pilot symbol may be configured to contain only pilot tones up to the maximum number of available tones. The configuration may be selected by downstream modem 504 during initialization.

(c) In the intermediate TDD frame immediately prior to the designated data bearing frame, the upstream modem 502 transmits pilot tones in the downstream transmission time slots. In this configuration, it may not be necessary to configure pilot symbols in the designated data transmission frame.

(5) In normal and/or low power states, to facilitate a timing recovery operation in the upstream modem 502, pilot tones may be transmitted by downstream modem 504 in the upstream direction. Use of upstream pilot tones and/or pilot symbols depends on the implementation of the timing recovery function in the upstream modem 502, so the use and configuration of the upstream pilot tones and/or pilot symbols may be configured by the upstream modem 502 during initialization.

(6) Additionally, if pilot tones and/or pilot symbols are used in the upstream direction, a logical low speed communication channel 508 to the downstream modem 504 (i.e. CPE device) may be provided in addition to the regular DSL channel 510 to communicate the upstream accumulated phase drift in the received upstream TDD frame for use by the downstream modem 502's timing circuit. Channel 508 may be implemented by inserting the information within the first downstream symbol in the next dedicated data transmission frame, for example.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method to facilitate timing recovery at a receiver in a time division duplex (TDD) communication system, comprising:
defining a maximum period of inactivity of downstream transmissions in a TDD frame;
specifying timing keep alive signals; and
transmitting the specified timing keep alive signals downstream to the receiver during the downstream transmissions.

2. A method according to claim 1, wherein the timing keep alive signals comprise pilot tones.

3. A method according to claim 2, further comprising inserting the pilot tones in data bearing symbols.

4. A method according to claim 2, further comprising inserting the pilot tones in non-data bearing symbols.

5. A method according to claim 1, further comprising using the transmitted timing keep alive signals to update a receive clock at the receiver.

6. A method according to claim 5, wherein updating is performed using a phase lock loop.

7. A method according to claim 1, wherein the maximum period of inactivity is defined based on a maximum permitted phase drift at the receiver.

8. A method according to claim 7, wherein T_{inactive} is the maximum period of inactivity and wherein φ_{drift} is the maximum permitted phase drift, and wherein T_{inactive} is determined according to
$${φ}_{drift} = {( \frac{Δ f}{{f}_{o}} )}_{ppm} \cdot {T}_{Inactive}$$
where Δƒ is a root-mean-square frequency variation to reference frequency ƒₒ.

9. A method according to claim 1, wherein the TDD communication system is in accordance with G.fast.

10. A method according to claim 9, wherein the TDD frame is in a L0 state.

11. A method according to claim 9, wherein the TDD frame is in a L.2.x state.

12. A time division duplex (TDD) communication system, comprising:
an upstream transmitter; and
a downstream receiver,
wherein the downstream receiver is adapted to define a maximum period of inactivity of downstream transmissions in a TDD frame and to specify timing keep alive signals,
and wherein the transmitter is adapted to transmit the specified timing keep alive signals downstream to the receiver during the downstream transmissions.

13. A TDD communication system according to claim 12, wherein the timing keep alive signals comprise pilot tones.

14. A TDD communication system according to claim 13, wherein the transmitter is adapted to insert the pilot tones in data bearing symbols.

15. A TDD communication system according to claim 13, wherein the transmitter is adapted to insert the pilot tones in non-data bearing symbols.

16. A TDD communication system according to claim 12, wherein the receiver is adapted to use the transmitted timing keep alive signals to update a receive clock at the receiver.

17. A TDD communication system according to claim 16, wherein updating is performed using a phase lock loop at the receiver.

18. A TDD communication system according to claim 12, wherein the maximum period of inactivity is defined based on a maximum permitted phase drift at the receiver.

19. A TDD communication system according to claim 18, wherein T_{inactive} is the maximum period of inactivity and wherein φ_{drift} is the maximum permitted phase drift, and wherein T_{inactive} is determined according to
$${φ}_{drift} = {( \frac{Δ f}{{f}_{o}} )}_{ppm} \cdot {T}_{Inactive}$$
where Δƒ is a root-mean-square frequency variation to reference frequency ƒₒ.

20. A TDD communication system according to claim 12, wherein the TDD communication system is in accordance with G.fast.
